(19) United States
(12) Patent Application Publication
(10) Pub. No.: US 2006/0272478 A1
(43) Pub. Date: Dec. 7, 2006

(54) CELLULAR RESIN COMPOSITE MUSICAL INSTRUMENTS

(76) Inventors: Dirk Steinhour, Lyle, WA (US); Jason Russ, The Dalles, OR (US)

Correspondence Address: SHERIDAN ROSS PC, 1560 BROADWAY, SUITE 1200, DENVER, CO, 80202, US

(21) Appl. No.: 11/382,909

(22) Filed: May 11, 2006

Related U.S. Application Data
(60) Provisional application No. 60/680,378, filed on May 11, 2005.

(51) Int. Cl. G10D 1/00; G10D 13/00

(52) U.S. Cl. 84/452 P

(57) ABSTRACT

A musical instrument, particularly a hand drum or a didgeridoo, molded of natural fiber-reinforced cellular composite materials designed to match tonal properties of wood. A sliding block cable tensioning device is employed to create tension on the skin.

### CROSS REFERENCE TO RELATED APPLICATION

This application claims the benefit of priority under 35 U.S.C. §119(e) to U.S. Provisional Patent Application Ser. No. 60/680,378 filed May 11, 2005, which is incorporated herein in its entirety by this reference.

### FIELD OF THE INVENTION

The invention resides in the field of composites, especially using fibers combined with cellular resin (foam) to create a material that is lightweight, strong, insulative, and impervious to moisture and UV light.

### BACKGROUND OF THE INVENTION

Wood fiber based composites are replacing the need for solid wood. They are a combination of fiber particles of varying size combined with a resin to bond them together. The result is a moldable, machinable composite that can be used in multitudes of ways similar to other wood fiber based composites such as particle board.

Hand drum shells are generally made from wood, ceramic, metal or fiber composites. There are several different types of skins that are stretched over the shell to provide the sound, but the use of different skins is unrelated to the material or method of shell construction. Each of the shell construction materials has certain advantages and disadvantages in ease of production or acoustic quality.

Wooden hand drums typically have the richest resonating sound. They produce the widest range of tone of any material in use. The cellular and fibrous nature of the wood creates this range, and these tones and the overall range of wooden tone frequencies are unattainable with constructions using ceramic, metal or non-cellular matrix fiber composites. Consequently, the demand for wooden hand drums with this rich sound results in a high demand for these instruments. Unfortunately, this demand has led to over harvesting of the native woods used to make these instruments and the further destruction of a threatened natural resource. Additionally, because wooden drums are very difficult to make accurately, many poor quality wooden drums are produced, wasting resources on low-quality instruments.

Wooden drum shells are made by carving or machining a shell, which is made-up of wood, or pieces of wood glued together. The outside is usually carved on a lathe or hand hewn and the inside is either carved on a lathe or carved and burned out to form the shell. While the outside is easily carved with ornate detail for improved appearance and appeal to the consumer, it is very difficult to carve or machine the inside. Therefore, the inside is typically very rough and irregular, resulting in poor acoustic amplification and tonal qualities. For example, the amplification cone or the constriction is not concentric or parallel to the head and the distance between the head and the constriction is uneven. Both of these qualities are necessary for good sound amplification and range of tone. This hand hewn, rough shape does not form the sound wave ideally, and these imperfections lead to sound distortion and loss due to the imperfect nature of the inside of the shell. Alternatively, wood drums can be machined entirely by CNC machines, but the cost of machining and tooling make this method impractical for creating drums at a reasonable cost.

There are innumerable other methods to create hand drums using wood. They all include carving or machining, which is very time consuming. Another type of wooden drum construction is a wood strip drum. They are created using wood strips pre-machined to fit together in a circular arrangement, glued together, and sometimes finished by turning on a lathe. Although non-circular, the multi-faceted inside of the wood strip drum is much more concentric and smooth than hand-carved or machined wooden drums. Unfortunately, wood strip drums are very time consuming to make and the inside is multi-faceted, not perfectly circular. Also, because of their open cell nature, wooden drums are difficult to keep in tune due to everpresent changes in relative humidity.

Ceramic materials offer a proven way to produce a drum that has a concentric and parallel conic inner section. Ceramic drums are generally created on a potter's wheel, allowing the drum to have a consistent, smooth outside and inside shape. Although the true shape on the inside amplifies the sound wave properly, the ceramic shell material is hard, thin walled, non-fibrous and non-cellular. This results in a drum sound that makes a unique sound that is very different from the tonal range and warm sounds of a wooden drum. Ceramic drums are known mostly for their high pitch “pop” tones and do not mimic the range of tones that wooden drums offer. They are also moderately expensive due to the time involved for manufacturing. Additionally, they are typically very fragile and heavy.

Metal drum shells are made by machining or forming metal into the shape of the shell. There are a wide variety of shapes and metals used, but metal drums have a “tinny” sound range and do not sound like wooden drums due to the tonal properties and resonant frequencies of the metal shell. The material is relatively hard and non-cellular and has no fiber. Metal drums are less time consuming to make than wood drums and are resilient, but have limited range of sound and minimal warmth of tone. Furthermore, most metal drums are susceptible to corrosion.

Shells made with wood fiber composites or formed laminates have a true inside shape since they are formed inside and outside. The inside is smooth, concentric and parallel to the head which creates an efficient sound wave and maximizes the drum's ability to make sound. Wood fiber composite drums have a sound more like wood than other materials, but do not adequately achieve the tones of a natural wood drum and are not easily moldable. They are tough, lightweight, corrosion-proof, and do not fluctuate with changes in relative humidity.

To make wood fiber composite drums, wood chips, wood powder or sawdust are collected and the fiber is re-oriented and formed into a laminate with resins to hold it together. These laminates can be manipulated into drum shapes, with some post molding or machining required. This is a cost effective method of constructing drums but is still too difficult compared to truly moldable materials. Furthermore, while the wooden composite drum is easier to make and has some wood tones and resonance, the resins are typically non-cellular so the sound is dissimilar to a wooden drum. Because a large part of the drum shell is the resin, the sound and tone is produced, in part, from the nature of the resin. The more wood fiber incorporated, the more wood-like the sound, yet the harder it becomes to form, and the irregularities of forming rather than true molding require considerably more finish work.

Therefore, there exists a need for truly molded musical instruments that closely match the resonance and tonal properties of wood and have a very true shape inside.

Similar to drums, didgeridoos are made of wood or, less often, plastic or metal tubing or other inexpensive materials. Most often, they are laboriously carved or machined from wood. Just like a drum, the overall tones of the instrument are a factor of the shape and the resonance of the material used for construction of the body. Therefore, these is a similar need to replace the wood used to make didgeridoos with a material that is moldable, machinable and reinforced with a sustainably-harvested natural fiber.

Skins are stretched over a drum shell to create the beating surface of the drum. Drum tuning is the method of tightening the head of the drum to the desired tension, arid then adjusting the tension to compensate for changes in relative humidity and stretching of the natural skin head. Tuning is necessary to keep the skin under the appropriate tension to generate the tones that the drum shell is designed for. Tuning can also be adjusted to the musician's preference to generate a particular tone.

One way in which drumheads are tensioned on the drumhead is by permanently affixing the head to the drum under tension. This method only works with non-stretch synthetic skins which have poor sound quality and results in an instrument that can never be adjusted for tone. Furthermore, the user cannot replace the drum head if it becomes torn or heavily worn.

There are many ways in which a drumhead may be adjustably-tensioned on the body of the drum. Most of the current tensioning systems use rope. In one popular rope system, the rope is threaded from a metal ring at the head of the drum to a ring that is put over the bottom of the drum shell. The rope is strung back and forth, between the bottom ring and the head, and then tightened using a compounding weave pattern. Rope loops are sometimes woven on the ring to accept the rope that crisscrosses between rings. In another form, the ropes make individual loops that can be tightened independently.

Rope systems are heavy because of the amount of rope that must be used to create an effective tensioning system. Furthermore, most users find it difficult to learn the compounding weave that must be understood in order to add tension to the drum head. Rope systems with independent loops are more difficult to tune because there are so many points at which tension is added. Thus, it is very time consuming to assemble drums with the rope tensioning system or just to change the tension and/or change the drum head.

Leather strapping is also traditionally used to tension drum heads. The head is tensioned either by compounding weaves or natural drying. This method is most often used on drums which are skinned on both ends of the shell. This method does not allow for easy tuning, and replacement of the head is very difficult.

There are mechanical systems which use bolts or cables loaded in tension to pull down on a metal ring which distributes the tension around the head. This system is expensive to machine and is very heavy and bulky. It usually has several tuning points and therefore is difficult to apply tension evenly. Cables have been used to replace the bolts, but this system still requires tensioning at many points.

Therefore, there also exists a need for a tensioning device that allows the user to easily tune the drum by adjusting tension for the drum head.

### SUMMARY OF THE INVENTION

In one part, the invention provides a composite material that is both fibrous and cellular throughout, not just in part, allowing for rich wooden tones and range of sound when used as a musical instrument body. Preferably, the fiber comes from a ubiquitous, sustainably-harvested, and renewable resource and the resin is cellular and has recycled content. If possible, it is a closed cell composite for consistent tune-ability and a lighter in density than noncellular resin composite drums. The musical instruments formed from these materials are non-corroding and weather resistant. Similarly, by fine-tuning the density, these instruments can achieve wood-like tones and resonance and a natural fiber composite may be used to precisely mold the shape needed to amplify the desired tones. In many instances, the instruments can be molded “in tune” by virtue of the molded shape, and therefore require no post-manufacturing tuning.

One embodiment is a method of making a resin composite including applying a cellular resin to a musical instrument mold and curing the cellular resin in the mold in the presence of fiber particles to form a cellular resin-fiber composite musical instrument body. Preferably, the resin used in this method is a natural resin, urethane, isocyanate, epoxy, polypropylene, polyethylene, polybutylene, lignin, acrylic or a combination of these materials. The fiber is preferably carbon, aramid, ceramic, spectra, polyester, polypropylene, glass, hemp, linen, jute or cotton. The curing is typically conducted by heating the mold to a temperature of about 37° C. for a time between about 1 minute and about 20 minutes.

In a preferred embodiment, a cellular resin composite musical instrument is provided that includes a resin encasing a fiber such as carbon, aramid, polyester or polypropylene, glass, hemp, linen jute and cotton. Preferably, the resin is urethane or polylactic acid, and the fiber is hemp fiber or bamboo fiber.

These instrument bodies may also have a surface covering that includes hemp fiber impregnated with an epoxy resin.

In two preferred embodiments, the musical instrument body is the body of a drum or a didgeridoo.

Another embodiment is a method of making a musical instrument body by applying a cellular resin to a musical instrument mold containing fiber particles and curing the resin in the mold. A skin is then applied to the surface of the cured resin. The skin may be applied by stretching a braided tubular band of fiber over a surface of the cured resin.

Another embodiment is a tensioning system for a drum head. The tensioning system contacts the head of the drum in only one or two points yet spreads the tension very evenly around the head. The tensioning system stretches like rope and is lightweight and unobtrusive. Additionally, system allows the user to replace the head quickly and it is very simple for the user to add or subtract tension using the system.

In this embodiment the tensioning system for a drum head includes a tensioning cable and at least one cable guide that positions the tensioning cable around the drum. This system includes at least one ring that is releaseably attached to the drum head and cable guide(s). Tension applied to any point on the tensioning cable is transmitted to the drum head through the cable guide(s) and ring(s). The tensioning cable may be a metal cable. Preferably, there are at least two cable guides spaced symmetrically around the head of the drum. In one embodiment, the cable guide(s) is/are integrated directly into the ring(s) such that the rings and the cable guides form one single component. Rings may also be positioned at the bottom of the drum opposite the drum head and attached to the tensioning cable.

In one embodiment of the tensioning system, a housing is provided that includes a sliding block that is located within the housing and attached to one end of the tensioning cable. The sliding block is then positioned within the housing to apply or to remove tension from the tensioning cable.

In another embodiment, a tensioning cable is attached to a servo motor that is configured to apply or release tension on the tensioning cable and thereby increase or decrease the tension on the ring(s) and thus, the drum head. A digital tuner may be optionally connected to the servo motor and adapted to increase and decrease tension on the tensioning cable by activation of the servo motor such that the tuning of the drum through the adjustment of tension on the drum head is adjusted automatically by the digital timer through the servo motor.

Another embodiment is a drum that includes a drum body formed from a resin including at least one of urethane and polylactic acid, that encases a fiber including carbon, aramid, polyester, polypropylene, glass, hemp, linen jute or cotton and a tensioning system for the drum head that includes a tensioning cable and at least one ring that is releaseably attached to the drum head, such that tension applied to any point on the tensioning cable is transmitted to the drum head through the at least one ring.

### BRIEF DESCRIPTION OF THE DRAWINGS

FIG. 1 is a photograph of one drum embodiment of the present invention.

FIG. 2 is a schematic drawing of a tensioning system of the present invention.

### DETAILED DESCRIPTION OF THE INVENTION

The present invention overcomes the problems of the prior art described above by providing a moldable cellular-resin fiber composite material that can be easily shaped to make musical instrument bodies with acoustic qualities closely matching wood. This composite material may be matched with additional instrument devices such as tensioning devices for drum heads.

The resin composite material is shapeable, machine-able and moldable and, due to its fibrous and cellular nature, it has material properties more closely resembling wood than existing wood fiber composites made with non-cellular resins despite the fact that these non-cellular, or “closed,” resins may contain very high amounts of wood. Also, this material can be fine-tuned to match the tonal properties of relatively scarce woods traditionally used in instrument building.

The fiber composite is a combination of resin and fiber. The cellular resin can be natural or synthetic and may also be either thermoplastic or thermosetting. An example of a natural resin particularly suited to the composite materials of the present invention is lignin or poly lactic acid. Preferably, synthetic expanding resins are used in making the fiber-resin composites of the present invention. Particularly preferred resins for use in the present invention include expanding urethane, isocyanates, epoxy, polypropylene, polyethylene, polybutylene, lignin, acrylic or combinations thereof.

The composite materials are made with a cellular resin to match the cellular nature of the fiber particles, without the use of non-cellular resins. This offers a lightweight alternative to bonding the particles and, with the overall greater cellular nature, can be fine tuned to match the tonal and aesthetic properties of light woods. Furthermore, the natural fiber composite drum is ecologically improved with the use of sustainably-harvested fibers like hemp. This gives the material integral strength and improved resistance to ultraviolet light, producing unequalled performance in outdoor applications.

Non-cellular or “closed” resins may be used to form the cellular resins used with the present invention by first modifying the closed resins to include microballons or similar polymer additives used to create cells. These microballons or polymer additives are first mixed with the closed resin to form a cellular resin that is then added to the mold and cured in the presence of the fiber particles.

Fibers for use in the composite can be synthetic or natural. Examples of synthetic fibers suitable for use in making the composite resins of the present invention include carbon, aramid, ceramic, spectra, glass, polyester or polypropylene. Examples of natural fibers suitable for use in making the composite materials of the present invention include hemp, linen, flax, jute, bamboo and cotton. These fibers can also be combined to include combinations of natural and/or synthetic fibers with the chosen resin composition. Preferably, natural fibers that are renewable and sustainable are used in making the composite materials of the present invention. Most preferably, the fiber used is hemp. Additionally, hemp hurd particles can be used to reinforce the core of the composite, while more expensive hemp fiber is placed at the skin for greater strength and UV protection.

The composite is formed by preparing the cellular resin and applying the resin to the mold in which the chosen fiber particles are packed or have been previously mixed with the resin. Depending upon the resin that is chosen, the resin may be prepared by melting or mixing immediately prior to application to the fiber-packed mold. Resin may also be injected into the mold. In a preferred embodiment, the resin is urethane that is prepared by mixing the fiber or hurd particles with the components of a two-part cellular resin system to form a foam/fiber mixture that is added to the mold. The two-part resin system is composed of a reactant and a resin that, when mixed together, react to form a foam. The resin can be fine tailored to match the density of traditional African woods. This is done by varying the density of the individual components and/or the amount of material delivered into the given volume of a part of the musical instruments when molded. When the two parts are mixed, the reactant forms cells, causing the material to expand and cure. The material is placed in the mold, and the mold is closed. After the composite has cured, it is removed from the mold. The foam expands to fill all voids and completely encapsulate the fiber and hurd particles in the mold. The time and temperature of curing will depend upon the resin used, but is typically between about 1 minute and about 90 minutes at a temperature between room temperature and about 66° C. Preferably, the resin is cured in the mold for about 15 minutes at about 43° C.

In a preferred embodiment, a two-part foaming urethane system is used to construct the resin. The density of the resulting fiber composite is between about 5 lbs/cu.ft. and about 30 lbs/cu.ft. The use of additional fiber reinforcement can create wooden tones and greater structural integrity. These fibers can be pre-placed in the mold as necessary to engineer the composite for the desired tonal characteristics.

Optionally, the resin is used without the addition of a fiber added to the mold. In this embodiment, any of the suitable resins and reactants described above may be added to the mold and cured in a manner essentially identical to the methods described above but in the absence of fiber particles packed into the mold or having been previously mixed with the resin.

After curing, the resin fiber composite is removed from the mold. The resin-composite drum body may be further treated to shape, smooth and finish the structure. Additional steps are typically taken at this stage to prepare the musical instrument for final assembly. For example, a drum body may be prepared for fitting with a drum head and, if desired, a tensioning system for the head. Optionally, the resin composite may be treated to include a surface coating of additional resin and fiber structures. Additional fiber may be added to the surface of the instrument to enhance the visual and aesthetic appearance of the instrument or to add additional structural support. Added fibers and other treatments may also further serve to tune the instrument to produce a desired sound quality from the instrument.

In a preferred embodiment, additional fiber is added to the surface of the resin composite instrument to add structural integrity and a more aesthetically-appealing surface finish. In this embodiment, the additional natural fibers are applied to the surface of the instrument and an epoxy resin is applied to the surface and cured. Preferably, the fiber is applied as a braided tubular band of fiber that is stretched and arranged over the surface of the composite core. The resin composite is then placed in another mold and an epoxy resin is added to the mold. The epoxy resin is then cured over the fibers covering the surface by curing at about 93° C. for about one hour. The resin composite is then removed from the mold with the fiber covering and may be treated to further smooth or texture the surface as desired.

Composites of a suitable resin with a blowing agent (reactant) and natural fibers are easily molded and have a cellular nature that allows fine-tuning to match the properties of desired woods. Fibers can be placed within or around the cellular resin to mimic the fibrous nature of wood and give the resulting instrument body structural integrity.

The warm sounds and range of tone of wood drum shells are easily produced using the natural fiber composites of the present invention. The molded shape generates an efficient sound wave with little waste, and the thickness, integral fiber and cellular nature of the synthetic wooden drum formed from the natural fiber composites allows for great resonance and incredible range of tone.

The molded construction yields a concentric, true conic section on the inside of the drum, taking all the sound energy from the head and amplifying it with little waste due to uneven, rough hewn, out of parallel or non-concentric shapes.

Many musical instruments produced from the natural fiber composites of the present invention can be made to match tones of woods that are extinct or nearly extinct. Many woods have been traditionally used to make different musical instruments due to their warmth of tone and resonance. The trees from which these woods are harvested have been depleted and in many areas are extinct or facing extinction. Synthetic musical instruments made from natural fiber composites of the present invention have wood-like tonal properties and can be manufactured without the continued destruction of the traditional woods, thereby preserving this precious natural resource.

Synthetic musical instruments are relatively easy to manufacture using the natural fiber composites of the present invention and are very lightweight, impervious to moisture and changes in humidity and therefore well adapted to travel. They are also incredibly tough and offer the musician the greatest range of sound and warm tones available in a non-wooden drum. The acoustical amplification of these instruments exceeds those of carved wooden drums, and they present the consumer with an option to conserve a vital resource in favor of one that is readily available and sustainably-harvested.

Another embodiment of the present invention is a didgeridoo formed from the composite resin material described above. Similar to other wooden instruments, didgeridoos produced from the natural fiber composites of the present invention can be made to match tones achieved with carved wooden instruments made from woods that are nearly extinct or take many years to grow to a suitable size for harvest. The tuning of a didgeridoo is generally performed after the instrument has been carved, by using beeswax poured down the tube, where it hardens and creates an opening that produces the desired sound characteristics for the instrument. The didgeridoo of the present invention is preferably produced such that the finished instrument is molded “in time” and no additional tuning is necessary. Like the musical instruments described above, the synthetic didgeridoos made from natural fiber composites of the present invention have wood-like tonal properties and can be manufactured without the continued destruction of the traditional woods, thereby preserving this precious natural resource.

The composites used to form a didgeridoo are formed by preparing the resin and applying the resin to the mold in which the chosen fiber particles are packed or have been previously mixed with the resin. Depending upon the resin that is chosen, the resin may be prepared by melting or mixing immediately prior to application to the fiber-packed mold. Resin may also be injected into the mold. In a preferred embodiment, the resin is urethane that is prepared by mixing the fiber with components of a two-part resin system to form a resin/fiber mixture that is added to the mold. The two-part system is composed of a reactant and a resin that, when mixed together, react to form a foam. The resin can be fine tailored to match the density of traditional woods. This is done by varying the density of the individual components and/or the amount of resin material delivered into the given volume of a part of the didgeridoo when molded. When the two parts of the resin are mixed, the reactant forms cells, causing the material to expand and cure. The material is placed in the mold, and the mold is closed. After the composite is cured, it is removed from the mold. The foam expanded to fill all voids and completely encapsulate the fiber particles in the mold. The time and temperature of curing will depend upon the resin used, but is typically between about 1 minute and about 90 minutes at a temperature between room temperature and about 65° C. Preferably, the resin is cured in the mold for about 15 minutes at about 43° C.

In a preferred embodiment, a two-part foaming urethane system is used to construct the resin. The density of the resulting fiber composite is between about 5 lbs/cu.ft. and about 30 lbs/cu.ft. The use of additional fiber reinforcement can create wooden tones and greater structural integrity. These fibers can be pre-placed in the mold as necessary to engineer the composite for the desired tonal characteristics.

After curing, the cellular resin fiber composite is removed from the mold. The resin-composite didgeridoo body may be further treated to shape, smooth and finish the structure.

Optionally, the resin composite may be treated to include a surface coating of additional resin and fiber structures. Additional fiber may be added to the surface of the instrument to enhance the visual and aesthetic appearance of the instrument or to add additional structural support. Added fibers and other treatments may also further serve to tune the instrument to produce a desired sound quality from the instrument.

As described above, skins are stretched over drum shells to create the playing surface of the drum. There are a number of ways this has been done over the centuries, but there are basically two types: fixed and tunable. As noted above, permanently affixed drum heads necessitate non-stretch synthetic skins that have poor sound quality and cannot be replaced by the musician. Tunable drums are beneficial to the musician because they allow the drum head tension to be adjusted to bring the drum into tune, much like a stringed instrument. This is important because drum skins, especially natural animal skins, are always in flux due to changes in the relative humidity or exposure to heat or sunlight. The tunable drum allows the user to compensate for variabilities caused by these fluctuations. Tuning can also be adjusted to the musician's preference, to generate a particular tone.

One embodiment of the present invention is a novel cable tensioning system that overcomes the problems of the prior art systems described above by combining two tensioning devices with a small diameter cable that runs through guides placed evenly around the head and neck of the drum. The guides are attached to rings; one of which is placed on the base of the bowl of the drum, the other is used to pinch the skin (with the use of a third ring) and placed over the head of the drum. The guides are attached to the rings at equidistant points around the drum and the cable can slide easily through the guides to evenly distribute the tension on the head of the drum that is created by the tensioning device.

The cable may be a metal or plastic cable having a diameter between about 0.25 millimeter and about 5 millimeters. Preferably, the diameter of the cable is between about 0.5 millimeters and about 2 millimeters. More preferably, the diameter of the cable is about 1.3 millimeters. The cable may be coated with a protectant made of plastic or similar chemicals to protect the cable from wear and to keep the drum and the user from making direct contact with the cable. The cable is ideal because it stretches far less than rope and is very lightweight.

The rings may be metal, plastic or wooden rings that are circular and sized to fit over the open end (bottom) of the drum but small enough to fit tightly against the lower portion of the drum and hold the guides against the bottom portion of the drum when tightened against a tensioning cable. Preferably, the ring or rings that hold the drum skin tightly in place while evenly distributing the tension from the tensioning cable over the head of the drum are not affixed to the drum, but rather floating on the drum head—holding the skin while being pulled taught by the tensioning cable. This floating ring approach is better than a fixed ring for eliminating unwanted frequencies created by the metallic nature of mechanical non-floating rings.

The guides may be any suitable material including metal, wood or plastic. Preferably the guides are metal to avoid stretching the guides resulting in uneven tension on the drum head. The guides are preferably in the form of pulleys that easily pass the tensioning cable without crimping or binding the cable. In one embodiment, the guides are small, circular pulleys attached to the rings around the top and bottom of the drum with webbing. The webbing forms a low profile union with the ring, which does not affect the drummer's hands in an adverse way. In a related embodiment, the guide can also be integrated into the top and bottom rings, so that the guides are internal to the rings, thereby enhancing the aesthetic appearance of the guides.

In a related embodiment, a tensioning cable applies tension to the ring or rings on the head of the drum. In this configuration, the tensioning cable runs directly to the rings without any cable guides or pulleys. This system relies on the rings to distribute the tension from the rings around the head of the drum. One or more of these connections between the tensioning cable and the rings may be present and spaced around the body of the drum. Preferably, two such connections are made between a tensioning cable and one or more rings on the head of the drum to evenly distribute the tension from the tensioning cable over the head of the drum.

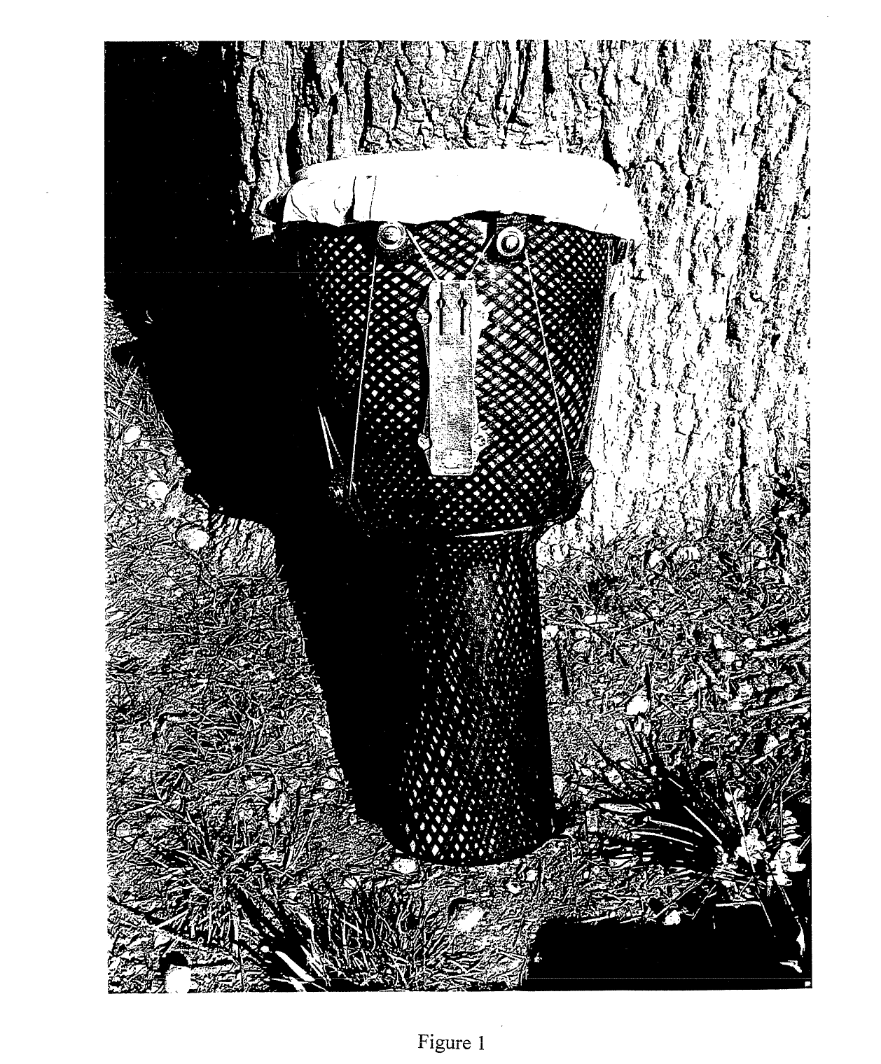

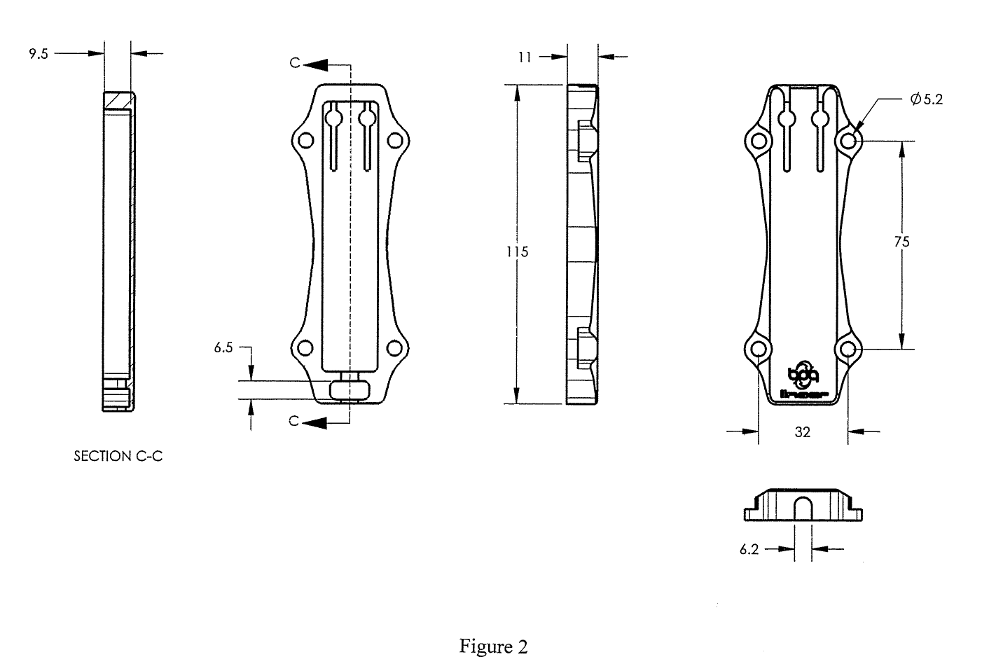

In one embodiment, the tensioning cable terminates in a sliding block within a housing. The housing (shown in FIG. 2) is affixed to the body of the drum and includes a bolt that functions as the drive mechanism for moving the sliding block within the housing, effectively controlling the tension on the tensioning cable. Thus, the tension on the tensioning cable is controlled by tightening or loosening the bolt, which moves the sliding block within the housing. Referring to FIG. 1, a tensioning cable is shown wrapped around the drum and entering a housing of one embodiment of a tensioning device of the present invention. A bolt at the bottom of the tensioning device controls the movement of a sliding block within the housing. Movement of the sliding block controls the tension on the tensioning cable thereby changing the tension on the head of the drum. This arrangement allows the user to tune the drum very easily by turning the bolt, using a simple allen key or the like, without learning an intricate weave pattern and without needing to add tension at many points.

The housing and the sliding block therein may be made of any suitable material. Additionally, these items may be configured and colored to have any aesthetically-pleasing appearance as applied to the exterior surface of a musical instrument.

A drum incorporating the tensioning systems of the present invention may include one or more of the housings and the sliding blocks therein. Preferably, there are two such housings, each providing a point of control over the tension on the tensioning cable, symmetrically located on opposite sides of a drum. This arrangement of two tensioning points helps to equally distribute tension to the head of the drum.

In a related embodiment, a mechanical servo motor may be added to the tensioning device—either alone or in conjunction with the housing described above. In this embodiment, the tensioning cable is directed to the servo motor which actuates the tensioning automatically. A digital tuner may then be added to this system to actuate the servo motor and apply or release tension. This combination of a digital tuner controlling a servo motor linked to the tensioning cable to apply or release tension from the tensioning cable functions to keep the drum in tune automatically. This eliminates the need for constant attention to the tensioning cable by the drummer.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of making a resin composite comprising:
a. applying a cellular resin to a musical instrument mold; and
b. curing the cellular resin in the mold in the presence of fiber particles to form a cellular resin-fiber composite musical instrument body.

2. The method of claim 1, wherein the resin is selected from the group consisting of natural resins, urethane, isocyanates, epoxy, polypropylene, polyethylene, polybutylene, lignin, acrylic or combinations thereof.

3. The method of claim 1, wherein the fiber is selected from the group consisting of carbon, aramid, ceramic, spectra, polyester, polypropylene, glass, hemp, linen, jute and cotton.

4. The method of claim 1, wherein the curing comprises heating the mold to a temperature of about 37° C. for a time between about 1 minute and about 20 minutes.

5. A cellular resin composite musical instrument comprising a resin encasing a fiber selected from the group consisting of carbon, aramid, polyester or polypropylene, glass, hemp, linen jute and cotton.

6. The cellular resin composite musical instrument of claim 5, wherein the resin is at least one of urethane and polylactic acid, and the fiber is at least one of hemp fiber and bamboo fiber.

7. The cellular resin composite musical instrument of claim 5, further comprising a surface covering comprising hemp fiber impregnated with epoxy resin.

8. The cellular resin composite musical instrument of claim 5, wherein the musical instrument is a drum.

9. The cellular resin composite musical instrument of claim 5, wherein the musical instrument is a didgeridoo.

10. A method of making a musical instrument body comprising:
a. applying a cellular resin to a musical instrument mold containing fiber particles;
b. curing the resin in the mold;
c. applying a skin to the surface of the cured resin.

11. The method of claim 10, wherein the applying step comprises stretching a braided tubular band of fiber over a surface of the cured resin.

12. A tensioning system for a drum head comprising:
a tensioning cable;
at least one cable guide that positions the tensioning cable around the drum;
at least one ring releaseably attached to the drum head and attached to the at least one cable guide;
wherein tension applied to any point on the tensioning cable is transmitted to the drum head through the at least one cable guide and the at least one ring.

13. The tensioning system of claim 12, wherein the tensioning cable is a metal cable.

14. The tensioning system of claim 12, comprising at least two cable guides wherein said guides are symmetrically-spaced around the head of a drum.

15. The tensioning system of claim 12, wherein the at least one cable guide is integrated into the at least one ring.

16. The tensioning system of claim 12, further comprising a ring connected to the at least one cable guide, said ring positioned at the bottom of the drum opposite the drum head.

17. The tensioning system of claim 12, further comprising a tensioning means comprising:
a housing;
a sliding block located within the housing and attached to at least one end of the tensioning cable;
a tensioning bolt that functions to position the sliding block within the housing and thereby apply or remove tension from the tensioning cable.

18. A tensioning system for a drum head comprising:
a tensioning cable;
at least one ring releaseably attached to the drum head and attached to the tensioning cable;
wherein tension applied to any point on the tensioning cable is transmitted to the drum head through the at least one ring.

19. A tensioning system for a drum head comprising:
a tensioning cable;
at least one cable guide that positions the tensioning cable around the drum;
at least one ring releaseably attached to the drum head and attached to the tensioning cable;
at least one servo motor attached to the tensioning cable adapted to increase or decrease tension on the tensioning cable;
wherein tension applied to any point on the tensioning cable is transmitted to the drum head through the at least one ring.

20. The tensioning system of claim 19, further comprising a digital tuner connected to the servo motor and adapted to increase and decrease tension on the tensioning cable by activation of the servo motor.

21. A drum comprising:
a drum body formed from a resin comprising at least one of urethane and polylactic acid, encasing a fiber selected from the group consisting of carbon, aramid, polyester, polypropylene, glass, hemp, linen jute and cotton; and,
a tensioning system for a drum head comprising:
a tensioning cable; and,
at least one ring releaseably attached to the drum head;
wherein tension applied to any point on the tensioning cable is transmitted to the drum head through the at least one ring.
